(19) United States
(12) Patent Application Publication
(10) Pub. No.: US 2026/0283242 A1
(43) Pub. Date: Sep. 24, 2026

(54) A HEATER FOR A HEAT-NOT-BURN DEVICE

(71) Applicant: JT International SA, Geneva (CH)

(72) Inventors: Alec Wright, Guildford (GB); Jaakko McEvoy, Vienna (AT); Takehiro Mitsutsuka, Geneva (CH)

(73) Assignee: JT International SA, Geneva (CH)

(21) Appl. No.: 19/472,456

(22) PCT Filed: Apr. 4, 2024
(86) PCT No.: PCT/EP2024/059229

§ 371 Date: Oct. 3, 2025

(30) Foreign Application Priority Data
Apr. 5, 2023 (EP) 23166731.2

(51) Int. Cl. A24F 40/46; A24F 40/70; H05B 3/03

(52) U.S. Cl. CPC A24F 40/46; A24F 40/70; H05B 3/03

(57) ABSTRACT

A heating assembly for a heat-not-burn device includes: a heater arranged around an internal heating cavity with an opening arranged to receive a consumable article; and an insulating layer bent about a first axis around the heater to cover at least a first outer surface of the heater and a second outer surface of the heater, wherein the second surface opposes the first surface, and wherein the insulating layer is bent about a second axis that is perpendicular to the first axis, to cover a third outer surface of the heater that connects the first surface to the second surface, wherein the insulating layer is sealed to form a wrapping around the heater.

### FIELD OF THE INVENTION

The present invention relates to a heater for an aerosol generating device, more specifically a heat-not-burn device.

### BACKGROUND

Typically, a heater in a heat-not-burn device comprises a cavity into which a consumable is inserted. The cavity may be formed from one or more walls, with each wall including a substrate upon which a heating track is formed. When electrical energy is supplied to the heating track via electrical contacts, the heat is transferred to the consumable and an aerosol is generated to be inhaled by the user.

One problem encountered with such devices is the limited efficiency. Since the substrate may have large thermal mass, a large amount of energy is required in order for it to reach the desired temperature, and the responsiveness of the heater to a control signal is reduced. Due to electrical connections and wires needing to be connected to the heating track, it may be difficult to insulate the heater from the remainder of the heat-not-burn device. Inadequate insulation further decreases the efficiency since not all of the heat generated is supplied to the consumable in the cavity.

Therefore, it is an object of the present invention to address the problems discussed above.

### SUMMARY OF INVENTION

According to an aspect of the present invention, there is provided a heater for a heat-not-burn device, comprising: a substrate; a heating track formed on the substrate; and at least one electrical contact positioned on the substrate at a location that is between a first point on the heating track and a second point on the heating track.

In this way, a notional line along the surface of the substrate connecting the first point and the second point preferably passes through the location of the at least one electrical contact. The at least one electrical contact is located in a “heating area” of the substrate that is occupied (or “filled”) by the heating track. Advantageously, this allows the heating track to fill the substrate, without the need for protrusions or spaces near the edges where electrical contacts can be positioned. This allows the size of the substrate to be reduced without decreasing the size of the heating track, which improves the overall efficiency of the heater without affecting performance. During use, an aerosol forming substance may be positioned adjacent to a surface of the substrate, such that heat generated by the heating track is transferred to the aerosol forming substance.

The substrate may have a base portion arranged to provide a base of a heating cavity, and a top portion arranged to provide a top of the heating cavity. The heating track preferably has a first portion adjacent to the base portion of the substrate, and a second portion adjacent to the top portion of the substrate.

In this way, the heating track may extend to both the top and the base of the heating cavity since space adjacent the top portion or base portion of the substrate does not need to be kept for providing the at least one electrical contact. This reduces the required size of the substrate and improves the efficiency of the heater.

The substrate may have a first side and a second side, each extending between the base portion and the top portion of the substrate, and the heating track may have a third portion adjacent to the first side of the substrate, and a fourth portion adjacent to the second side of the substrate.

In this way, the heating track may extend to both the sides of the heating cavity since space does not need to be kept for providing the at least one electrical contact. This reduces the required size of the substrate and improves the efficiency of the heater. The substrate may be substantially rectangular with its four edges corresponding to the base portion, the top portion, the first side and the second side. Preferably, the heating track substantially follows the perimeter of the substrate at other portions in addition to the first, second, third, and fourth portions (i.e., the heating area extends to the perimeter). It will be appreciated that non-rectangular substrates may be used to provide the heater. Where non-rectangular substates are used, the heating area preferably also extends to the perimeter of the substate.

Preferably, the at least one electrical contact is positioned in a central region of the substrate. In this way, the at least one electrical contact may be provided substantially at the centre of the heating area of the substrate.

Preferably, the substrate is substantially flat, thereby providing a planar surface upon which the heating track is formed. In this way, heater may be easily manufactured from a flat sheet of material. The substrate may be a ceramic substrate. The substrate may provide a wall of a heating cavity. Other such substrates may provide other walls of the cavity, such as two parallel walls defining a thin rectangular heating cavity therebetween. It will be appreciated that the substrate may instead have a profile that is not planar, such as curved.

Preferably, the at least one electrical contact comprises a pair of electrical contacts for supplying power to the heating track. In this way, further electrical contacts do not need to be provided elsewhere in order to supply power to the heating track; this allows the size of the substrate the be reduced and the efficiency of the heater to be improved.

The heater may further comprise a temperature sensor positioned on the substrate. The temperature sensor allows the temperature inside the heating cavity to be monitored. The temperature sensor may be connected in a feedback loop to control the temperature of the heater.

Preferably, the temperature sensor is positioned in a central region of the substrate. Preferably, the temperature sensor is also positioned at the centre of the heating area. In this way, the temperature sensor may more accurately monitor the heat supplied to an aerosol forming substance inserted adjacent to the heater.

The at least one electrical contact may comprise a pair of electrical contacts that are connected to the temperature sensor.

The heater may further comprise at least one wire extending from the at least one electrical contact, preferably wherein the wire extends from the substrate in a direction perpendicular to the substrate. This may facilitate connections to other parts of a heat-not-burn device, such as a power supply (for connecting to the heating track) and/or processors or control circuitry (for receiving the output of the temperature sensor).

Preferably, a portion of the at least one wire is bent in a direction that is parallel to the substrate.

An insulating layer (or “insulating plate”) may be positioned over or against a surface of the substrate. The insulating layer may be positioned on an opposite surface of the substrate to the surface against which the aerosol forming substance is positioned, during use. The combination of the insulating layer and the heater may be referred to as a “heating assembly”. The term “insulating” preferably indicates that the layer is thermally insulating but it will be appreciated that the layer may also be electrically insulating. In this way, the amount of heat that is supplied to the aerosol forming substance is increased, since heat flow in directions away from the aerosol forming substance is inhibited. The insulating layer may comprise Superwool® or Finesulight™. The insulating layer may be from about 1 mm thick to about 3 mm thick.

The substrate may be a first substrate, and the heater may further comprise a second substrate arranged parallel to the first substrate, such that a heating cavity is provided therebetween. This provides a substantially cuboid shaped heater. The second substrate is preferably similar to the first substrate, and therefore comprises a second heating track formed on the second substrate, and at least one electrical contact positioned on the substrate as described above and herein. Any of the optional features presented above may also apply to the second substrate.

According to another aspect of the present invention, there is provided a heat-not-burn device comprising the heater as described above and herein.

According to another aspect of the present invention, there is provided a heating assembly for a heat-not-burn device, comprising: a heating substrate having a surface that is substantially flat; a heating track formed on the surface of the heating substrate; an electrical contact positioned on the surface of the heating substrate; a wire connected to the electrical contact, the wire extending from the heating substrate; and an insulating layer positioned over the surface of the heating substrate, the insulating layer arranged to provide an opening through which the wire extends.

In this way, the insulating layer (or insulating plate) may be located over the flat (planar) surface of the heating substrate while still allowing the wires to pass therethrough to connect to other parts of the heat-not-burn device. It will be appreciated that other parts of the heating substrate other than the surface, are not necessarily flat. The insulating layer may be positioned directly against the surface of the heating substrate. Alternatively, a small gap or air layer may be provided between the insulating layer and the surface of the heating substrate. The insulating layer may comprise Superwool® or Finesulight™. The insulating layer may be from about 1 mm thick to about 3 mm thick.

Preferably, the wire extends from the heating substrate in a direction that is substantially perpendicular to the surface of the heating substrate. This may allow the size of the openings in the insulating layer the be reduced, and the construction of the openings may be simplified.

The heating assembly may further comprise a plurality of electrical contacts arranged on the surface of the heating substrate, each electrical contact connected to a corresponding wire.

The insulating layer may comprise a first portion and a second portion that are positioned over the heating substrate with a gap therebetween that provides the opening. The first portion and the second portion may be translated or slid over the surface of the heating substrate in order to position them, such as from the top or bottom of the heating substrate. The first and second portion may be translated until they abut against the wire connected to the electrical contact. Where a plurality of electrical contacts are present, they are preferably co-linear; this allows the insulating layer to be simply divided into the first and second portion along a straight line. It will be appreciated that the boundary between the first and second portion may have other shapes, such as to account for electrical contacts that are not co-linear, and/or to fill the space between electrical contacts.

The opening may be provided by a slot in the insulating layer that extends to an edge of the insulating layer, whereby the insulating layer is positioned by translation of the insulation layer over the surface of the heating substrate with the wire extending through the slot. Where a plurality of electrical contacts are present, they are preferably co-linear; this allows the slot to be a straight line (which is easier to manufacture), and allows the insulating layer to be easily slid into position along a single direction.

The opening may be provided by at least one hole in the insulating layer, whereby the insulating layer is positioned over the surface of the heating substrate by passing an end of the wire through the at least one hole. In this way, the holes prevent sliding of the insulating layer over the surface of the heating substrate, and the area of the heating substrate that is not covered by the insulating layer is reduced.

The insulating layer may comprise a plurality of holes, each hole corresponding to a separate wire. This further reduces the area of the heating substrate that is not covered by the insulating layer, since the holes only need to be large enough to fit a single wire. Preferably, each hole seals around its corresponding wire. Alternatively, more than one wire may pass through a single hole in the insulating layer.

Preferably, a portion of the wire that extends through the opening is bent into a direction that is parallel to the insulating layer, thereby retaining the insulating layer against the surface of the heating substrate.

The heating substrate may be a first heating substrate, and the heating assembly may further comprise a second heating substrate arranged parallel to the first heating substrate, thereby providing a heating cavity therebetween. This provides a substantially cuboid shaped heater. The second heating substrate is preferably similar to the first heating substrate, where an electrical contact is positioned on a surface of the second heating substrate, with a wire connected to the electrical contact, and an insulating layer positioned over the surface of the second heating substrate. The insulating layer covering the second heating substrate may be a separate insulating layer to the one covering the first heating substrate, or the heating substrates may be covered by the same insulating layer. Any of the optional features presented above may also apply to the second heating substrate.

According to another aspect of the present invention, there is provided a method of manufacturing a heating assembly for a heat-not-burn device, the method comprising: providing a heating substrate; positioning an electrical contact on a substantially flat surface of the heating substate; connecting a wire to the electrical contact; and positioning an insulating layer over the surface of the heating substrate, such that the wire extends through an opening provided by the insulating layer.

According to another aspect of the present invention, there is provided a heating assembly for a heat-not-burn device, comprising: a heater arranged around an internal heating cavity with an opening arranged to receive a consumable article; and an insulating layer bent about a first axis around the heater to cover at least a first (e.g., outer) surface of the heater and a second (e.g., outer) surface of the heater, wherein the second surface opposes the first surface, and wherein the insulating layer is bent about a second axis that is perpendicular to the first axis, to cover a third (e.g., outer) surface of the heater that connects the first surface to the second surface, wherein the insulating layer is sealed to form a wrapping around the heater.

The insulating layer may be wrapped about the first axis to cover the first and second surface while leaving the third surface of the heater initially unwrapped. Subsequently, the insulating layer may be bent about the second axis to cover the third surface, which provides a pouch shaped piece of insulating material containing the heater, where a (main) opening of the pouch aligns with the opening of the heating cavity. In this way, the wrapping is formed by sealing a single piece of insulating material to itself, without the need for other components (such as a separate base) to cover the third surface of the heater. Advantageously, this reduces the number of parts required to provide an insulating layer and simplifies manufacture. The first, second, and third surfaces are preferably outer surfaces of the heater. As used herein, the term “opposes” preferably indicates that the second surface is located on an opposite side of the heater to the first surface. The first and second surfaces may be parallel to each other. In this case, the third surface may be perpendicular to both the first and second surfaces (such as in the case of a cuboid shaped heater). Alternatively, the first and second surfaces may be curved or angled surfaces that are located on opposite sides of the heater. The third surface may also be curved or may be angled with respect to the first and/or second surface.

In order to allow the insulating layer to be bent about the second axis to cover the third surface, the insulating layer may have at least one edge that overhangs the third surface after the insulating layer is bent about the first axis. The at least one edge may overhang the third surface from the first surface and the second surface. Preferably, the heater contacts the bends of the insulating layer at least partially, so that the heater is wrapped relatively tightly by the insulating layer. The seal may be a crimp seal. Preferably, the insulating layer is sealed over the third surface of the heater. The seal may include a fold in the insulating layer. The insulating layer may comprise Superwool® or Finesulight™.

Preferably, the first, second, and third surfaces are each substantially flat or planar. Preferably, the first, second, and third surfaces are connected by straight edges. Preferably, the heater has a cuboid shape. In this way, the insulating layer can be bent around the edges to cover each of the surfaces of the heater while reducing the amount of folding and/or creasing of the insulating layer. Additionally, the wrapping is particularly advantageous when used with a cuboid shaped heater, since cuboid shaped heaters (having flat surfaces) have a larger surface area than heaters with curved surfaces (such as cylindrical heaters), and therefore it is particularly advantageous to reduce heat loss from cuboid heaters.

Alternatively, the heater may have other shapes such as cylindrical. Thus, the first, second, and third surfaces are not necessarily connected by edges but may be connected by smooth surfaces. In this case, the insulating layer may still be bent around the first and second axes to cover the first, second, and third surfaces of the heater, and the insulating layer may include additional folds or creases so that it is still wrapped relatively tightly around the heater. In this way, the wrapping can be used to provide insulation for other shapes of heater.

Preferably, the third surface of the heater is at a base of the heater opposite to the opening of the heating cavity. In this configuration, the first axis corresponds to bending of the insulating layer about a longitudinal axis of the heater, and the second axis corresponds to bending of the insulating layer under the base about an axis perpendicular to the longitudinal axis.

Alternatively, the third surface may be a side of the heater, where the first axis may correspond to bending of the insulating layer under the base, and the second axis may correspond to bending the insulating layer around at least one side of the heater before the seal is formed along the side of the heater.

The heater assembly may further comprise one or more additional insulating layers, each bent to cover at least the first surface and second surface of the heater, wherein at least one of the insulating layers is bent about the second axis to cover the third surface of the heater and sealed. Preferably all of the insulating layers are sealed, thereby providing a plurality of nested insulating pouches.

Preferably the (or each) insulating layer is less than 1 mm thick. The heater may comprise at least one corner over which the insulating layer is bent (either about the first axis or the second axis). For example, the heater may be a cuboid, where the corners are 90-degree angles. Thinner insulating layers (for example, layers that are less than 1 mm thick) may be wrapped (folded) more sharply around edges or corners of the heater. Where several insulating layers are used, the total thickness may be about 3 mm.

The heating assembly may further comprise a wire extending from an external surface of the heater, and wherein the insulating layer comprises an opening through which the wire extends. The opening is different to the main opening that is aligned with the opening of the cavity. The opening may be a hole, with the wire being passed through the hole prior to wrapping the insulating layer around the heater (i.e., preferably before bending of the insulating layer about either the first axis or the second axis). Alternatively, the openings may be slots so that the wire may be disposed through the slot by sliding or folding of the insulating layer, such as during the bending of the insulating layer during the wrapping process. Preferably, the size of the opening is minimized with dimensions that fit around the wire, thereby forming a seal around the wire. Additional wires may be provided, which may supply electricity to heating elements (e.g. a heating track) of the heater, and/or may connect to a temperature sensor adjacent to the heating cavity. The wires may be connected on different sides of the heater.

Preferably, a portion of the wire that extends through the opening is bent against an external surface of the insulating layer. This retains the insulating layer against the surface of the heater. Additionally, this allows the wires to connect to other parts of the device (e.g., power supply or control electronics) that are located around the heating assembly without them needing to be located directly over the wires.

Preferably, an air layer is provided between the insulating layer and the heater. Advantageously, the air layer provides additional insulation due to the low specific heat capacity of air. It will be appreciated that the air layer could be filled with another insulating material. For example, the air layer may be provided between the insulating layer and the third surface of the heater; in other words, the insulating layer is not sealed directly against the third surface after bending about the second axis, such that an air pocket is formed therebetween. By providing an air pocket, the third surface of the heater (e.g., the base) is better insulated, thereby increasing the efficiency of the heater.

Alternatively or additionally, the air layer may be provided by positioning the wire between the insulating layer and the heater. In this way, a separate spacer is not required to maintain the air layer. Preferably, the wire is bent between a first insulating layer and a second insulating layer, thereby providing the air layer therebetween. Where further insulating layers are wrapped around the heater, the wires may be bent to space apart any adjacent pair of insulating layers. Where multiple wires are present, they may be bent between different pairs of insulating layers, so that multiple air layers are provided. At least one of the wires may be bent over the external surface of the outermost insulating layer.

Preferably, the opening of a first insulating layer is covered by a second insulating layer. For example, where the wire extends through a slot in the first insulating layer, the same wire may extend through holes in the second insulating layer (or vice versa). Where wires extend from opposite sides of the heater, each wire may alternate between passing through a slot and passing through a hole. In some scenarios holes (that are tightly sealed around the wires) may provide better insulation than slots (that leave areas uncovered), which means that all sides of the heater are covered by at least one insulating layer.

The heater may comprise: a first heating substrate providing the first (e.g., outer) surface of the heater, and a second heating substrate arranged parallel to the first heating substrate, the second heating substrate providing the second (e.g., outer) surface of the heater and a substantially planar heating cavity between the first heating substrate and the second heating substrate. This provides a cuboid heater, where the insulating layer is bent over edges that are substantially straight, which allows the heater to be covered without substantial creases in the insulating layer. On the other hand, where the heater has a curved (e.g. cylindrical shape), the insulating layer may become creased if bent to cover the base. Where additional folds or creases are used to wrap the insulating layer tightly around the heater, additional sealing may be used (e.g., between different folds in the insulating layer), to retain the insulating layer in its wrapped state.

According to another aspect of the present invention, there is provided a heat-not-burn device comprising the heating assembly as described above and herein.

According to another aspect of the present invention, there is provided a method of manufacturing a heating assembly for a heat-not-burn device, comprising: providing a heater arranged around an internal heating cavity with an opening arranged to receive a consumable article; bending an insulating layer about a first axis around the heater to cover at least a first (e.g., outer) surface of the heater and a second (e.g., outer) surface of the heater, wherein the second surface of the heater opposes the first surface; bending the insulating layer about a second axis, perpendicular to the first axis, to cover a third (e.g., outer) surface of the heater that connects the first surface to the second surface; and sealing the insulating layer of the heater to form a wrapping around the heater.

The method may further comprise bending one or more additional insulating layers around the heater to cover at least the first surface and second surface thereof, with at least one of the insulating layers being bent about the second axis to cover the third surface of the heater and sealed.

The method may further comprise connecting a wire to an external surface of the heater, and disposing the wire through an opening in the insulating layer prior to bending of the insulating layer about either the first or second axes.

Preferably, the opening of a first insulating layer is covered by a second insulating layer.

It will be appreciated that any features of any of the aspects defined above and herein may be provided in any suitable combination. Moreover, optional or preferable features from any one of the aspects above may also be included in any of the other aspects. It will be understood by a skilled person that any apparatus feature described herein may be provided as a method feature, and vice versa. It will also be understood that particular combinations of the various features described and defined in any aspects described herein can be implemented and/or supplied and/or used independently.

Moreover, it will be understood that the present invention is described herein purely by way of example, and modifications of detail can be made within the scope of the invention.

### BRIEF DESCRIPTION OF DRAWINGS

One or more embodiments will now be described, purely by way of example, with reference to the accompanying figures, in which:

FIG. 1A shows an embodiment of an aerosol generating device;

FIG. 1B shows a cross-section through the aerosol generating device to show a heating assembly comprising a heating substrate;

FIG. 2A shows an example of a typical heating substrate having a heating track, and electrical contacts positioned towards a base of the substrate;

FIG. 2B shows a consumable positioned inside a heater formed with the typical heating substrate of FIG. 2A;

FIG. 3A shows an embodiment of a heater that may form part of a heating assembly, the heater having a heating substrate with electrical contacts positioned on the substrate;

FIG. 3B shows the heating substrate of FIG. 3A, with wires extending from the electrical contacts;

FIG. 4 shows a first example of an insulating layer that may form part of the heating assembly, the insulating layer having one or more holes;

FIGS. 5A to 5C show a method of positioning the insulating layer of FIG. 4 over the heating substrate of the heater;

FIGS. 6A and 6B show a second example of an insulating layer having a slot, and a method of positioning the insulating layer over the heating substrate of the heater;

FIGS. 7A and 7B show a third example of an insulating layer having a first portion and a second portion, and a method of positioning the insulating layer over the heating substrate of the heater;

FIGS. 8A to 8D show a fourth example of an insulating layer having both holes and slots, and a method of positioning the insulating layer by wrapping the insulating layer around the heater;

FIGS. 9A to 9D show an example of a heating assembly where a plurality of insulating layers are wrapped around the heater; and

FIGS. 10A to 10D show an example of a heating assembly where insulating layers are bent and sealed to form wrappings.

### DETAILED DESCRIPTION

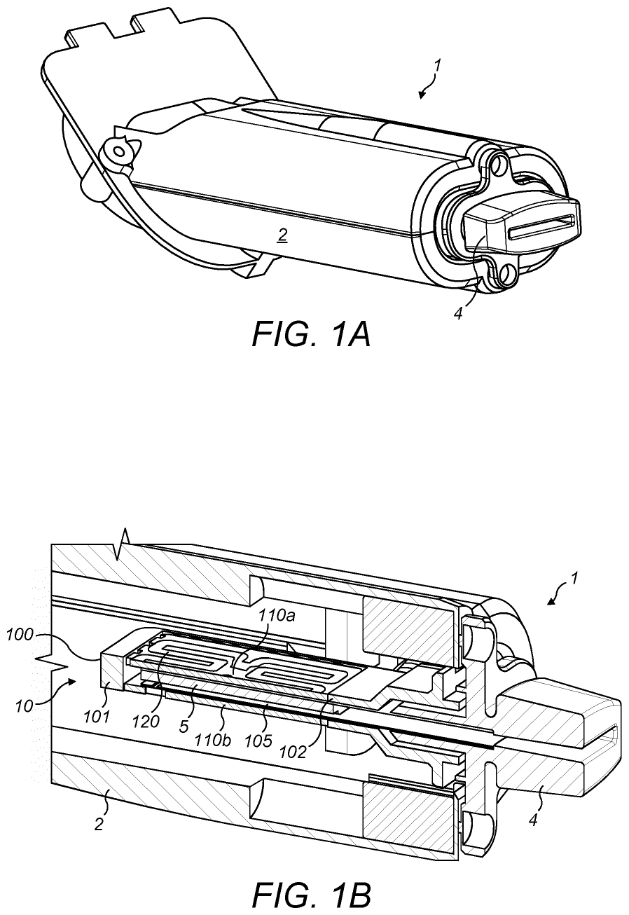

FIG. 1A shows an outer view of an aerosol generating device 1, and FIG. 1B shows a cross-sectional view of the aerosol generating device 1. The device 1 includes an outer casing 2 in which a heating assembly 10 is arranged. In this specific example, the heating assembly 10 is connected to a mouthpiece 4 from which aerosol can be inhaled by a user. It will be appreciated that the device 1 may have other components and functional portions (such as display and control circuitry) which are not described in detail herein.

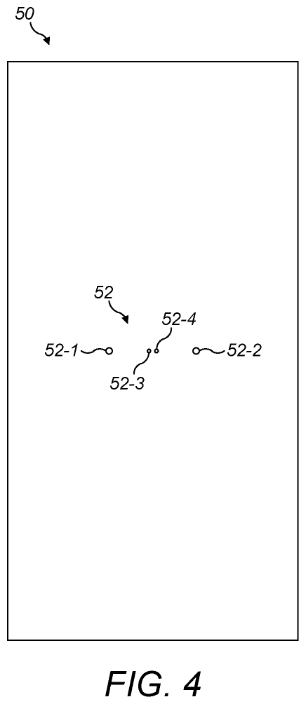

As shown in FIG. 1B, the heating assembly 10 comprises a heater 100. While not shown in FIG. 1B, the heating assembly 10 comprises insulating layers 50 around the heater 100, which will be described further in relation to FIGS. 4 to 10. The heater 100 comprises a first wall provided by a first heater substrate 110a, and a second wall provided by a second heater substrate 110b. In this example, the heater substrates 110 are formed from a ceramic material. The heater substrates 110 have a surface 118 that is substantially flat or planar. The first heater substrate 110a is arranged parallel to the second heater substrate 110b. In this way, the heater 100 has a substantially cuboid shape, with a cavity 105 formed between the substrates 110a, 110b that is substantially planar. Therefore, a substantially planar consumable 5 may be received in the cavity 105. During use, the consumable 5 is heated by the heater 100 to produce an aerosol. The consumable 5 comprises an aerosol forming substance and may be configured as a heat-not-burn consumable 5. Since the heater 100 is a cuboid shape formed from planar substrates 110a, 110b, it has an increased surface area as compared to other types of heaters such as cylindrical heaters. Therefore, it is particularly important to improve the energy efficiency of the heater 100.

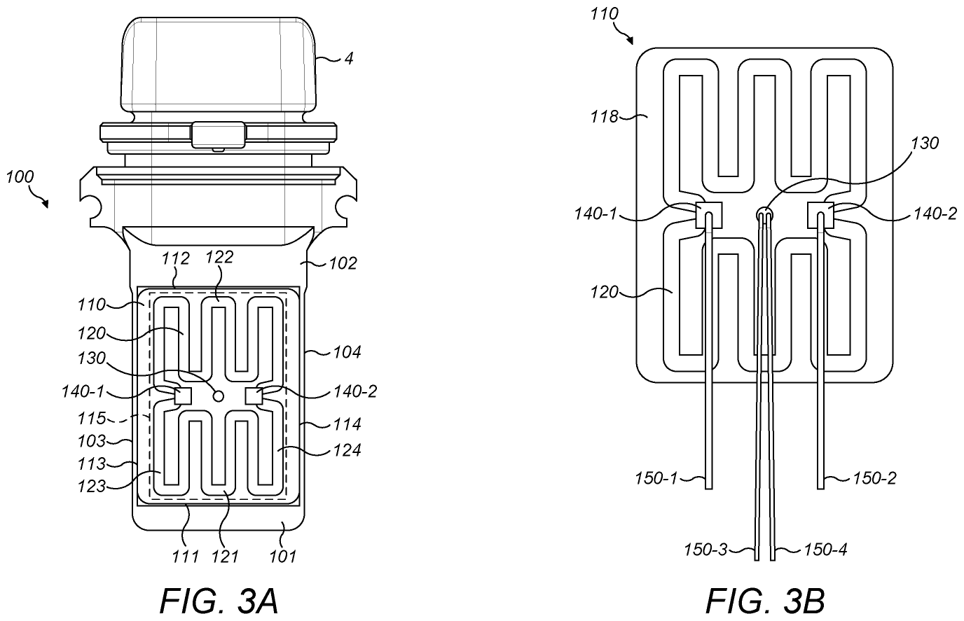

The heater 100 comprises a base 101 and side walls 103, 104 (shown in FIG. 3A). In this way, the edges of the cavity 105 are enclosed, so that the consumable 5 is retained at a consistent position in the cavity 105. A top 102 of the heater 100 is left substantially open in order to allow the consumable 5 to be inserted into the cavity 105. In other words, the top 102 provides an opening to the cavity 105. The mouthpiece 4 may be detachably connected to the top 102 of the heater 100/heating assembly 10 via an interface connection (not shown) to allow easier access to the cavity 105 (for inserting the consumable 5 or for cleaning, for example). Alternatively, the consumable 5 may be inserted into the cavity 105 through the mouthpiece 4.

A heating track 120 is formed on each of the substrates 110 (i.e., on the planar surface 118 of each substrate 110). The heating track 120 follows a winding pathway on the surface 118 of the substrate 110. The heating track 120 is arranged to receive electrical energy from a battery or power source (not shown) of the device 1 and generate heat to produce an aerosol from a consumable 5, when the consumable 5 is inserted into the cavity 105 of the heater 100. The electrical connection between the heating track 120 and the battery is provided by at least one electrical contact 140 positioned on the substrate 110, with each electrical contact 140 connecting to a respective wire 150.

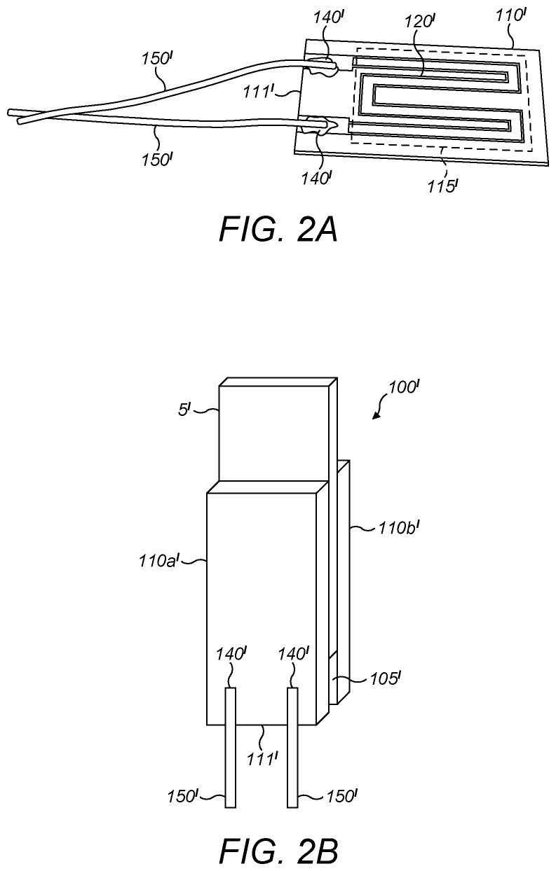

A typical heater substrate 110′ will now be described in relation to FIGS. 2A and 2B. As shown, the substrate 110′ has a heating track 120′ formed thereon. The electrical contacts 140′ are positioned at an end of the substrate 110′ (in this case near its base 111′) with the wires 150′ extending from the base 111′ in a direction substantially parallel to the plane of the substrate 110′. This allows for electrical connections to be made to the heating track 120′ in a simple way, and allows for other components to be located around the heater 100′ without being obstructed by the electrical contacts 140′ or the wires 150′. However, the area near the base 111′ cannot be used for heating the consumable 5′ during use. As a result, as shown in FIG. 2B, the consumable 5′ is not fully inserted into the cavity 105′ between the substrates 110a′, 110b′ since the area near the base 111′ does not generate sufficient heat to form an inhalable aerosol. However, especially where a ceramic is used for the substrates 110′, the area near the base 111′ still increases the thermal mass of the heater 100′, which means that it takes longer to heat up, and increases the size of the heater 100′ and the size of the device 1 as a whole. While FIGS. 2A and 2B depict the electrical contacts 140′ near the base 111′, it will be appreciated that the same problems are present when the electrical contacts are near any of the edges of the substrate 110′ such as the sides or the top.

A heater 100 will now be described in detail in relation to FIGS. 3A and 3B. FIG. 3A shows the heater substrate 110 installed in a heater 100 with a base 101, top 102, and side walls 103, 104. FIG. 3B shows the heater substrate 110 of the heater 100 connected to wires 150. It will be appreciated that any features provided in the following description may apply to the first heater substrate 110a and/or the second heater substrate 110b. It will also be appreciated that the first heater substrate 110a and the second heater substrate 110b need not be identical; for example, the heating track 120 provided on each of the substrates 110 may have a different pathway and/or the electrical contacts 140 may be positioned in different locations on the substrate 110. Alternatively, a single heater substrate 110 may be provided, with the opposite wall of the cavity 105 being provided by an unheated substrate or an insulating substrate. However, the present example has two substrates 110a, 110b in order to heat the consumable 5 from both sides.

As shown in FIG. 3A, the substrate 110 is substantially rectangular with a base portion 111, a top portion 112, a first side 113 and a second side 114. In this way, the first side 113 and second side 114 extend between the base portion 111 and the top portion 112. The base 101, first side 113, and second side 114 each provide a surface of the heater that joins the first substrate 110a to the second substrate 110b. Alternatively, the substrate 110 may have other (e.g., non-rectangular) shapes. The heating track 120 is formed on the planar surface 118 of the substrate 110. The heating track 120 follows a winding pathway on the substrate 110. A first electrical contact 140-1 and a second electrical contact 140-2 connect to the heating track 120, in order to allow power to be supplied to the heating track 120. In this example, the heating track 120 forms a closed loop, where the track 120 has two pathways that both connect the first electrical contact 140-1 to the second electrical contact 140-2. It will be appreciated that an open loop may also be used, such as a single pathway between the first electrical contact 140-1 and the second electrical contact 140-2. Furthermore, several winding pathways may form the heating track 120, and additional electrical contacts 140 may be used.

The heating track 120 is formed within a heating area 115 on the substrate 110. For illustrative purposes, the boundary of the heating area 115 is depicted using a dotted line in FIG. 3A, though it will be appreciated that this boundary is not typically visible. In this example, both the cavity 105 and the consumable 5 are rectangular, so the heating area 115 has a corresponding rectangular shape. The heating area 115 may be a shape other than a rectangle (which may be appropriate for non-rectangular cavities 105 and/or consumables 5). Generally, for any pathway of the heating track 120, the heating area 115 is defined as the convex shape (e.g., convex polygon) with the minimal area which surrounds all of the heating track 120. The heating area 115 substantially corresponds to the size and shape of the consumable 5 when it is inserted into the cavity 105. This means that all of the heating track 120 is used to heat the consumable 5, and that all of the consumable 5 is heated by part of the heating track 120. This reduces wasted energy (e.g., by heating parts other than the consumable 5), and reduces waste of the consumable 5 (e.g., by having parts that are not sufficiently heated to produce an aerosol).

The substrate 110 has a central region, which is defined as the region adjacent to the centre of the substrate 110 and/or the region adjacent to the centre of the heating area 115. The centre of the substrate 110 and/or the heating area 115 may be defined as the average position or centre of mass of the substrate 110 and/or the heating area 115.

A temperature sensor 130 is provided on the substate 110. In this way, it is possible to monitor the amount of heat being supplied to the consumable 5. This may allow optimal vaporisation and/or may prevent overheating (which may lead to production of unwanted vapour). The temperature sensor 130 has corresponding third and fourth electrical contacts 140 (not shown), each connecting to a corresponding wire 150. This allows the temperature measured by the temperature sensor 130 to be transmitted to other parts of the device 1, such as a control unit. For example, the temperature sensor 130 may be connected in a feedback loop to the power supply and heating track 120. In order to better monitor the temperature, the temperature sensor 130 (and its electrical contacts 140) is located inside the central region of the substrate 110.

The electrical contacts 140 are positioned on the substrate 110 at a location that is between a first point on the heating track 120 and a second point on the heating track 120. In this way, a (straight) line along the substrate 110 connecting the first point and the second point passes through the location of the at least one electrical contact 140. The first point and second point are not necessarily unique for each electrical contact 140, provided that a pair of such points may be found. In other words, where the heating area 115 is defined in the manner described previously, the at least one electrical contact 140 is located inside said heating area 115. As described above, the electrical contacts 140 include electrical contacts 140-1, 140-2 for supplying power to the heating track 120 and include electrical contacts 140 (e.g., a pair) for connecting to the temperature sensor 130.

By contrast, in the substrate 110′ described in relation to FIGS. 2A and 2B, it is not possible to find a straight line between two points on the heating track 120′ that pass through either of the electrical contacts 140′, since they are located adjacent to an edge (in this case, the base portion 111′) of the substrate 110′. In other words, the electrical contacts 140′ are located outside of the heating area 115′ of the heating track 120′.

Advantageously, by having the electrical contacts 140 between a first point and second point on the heating track 120, the heating track 120 may fill the substrate 110, without the need for protrusions or spaces near the edges for the electrical contacts 140. In the rectangular heating area 115 shown in FIG. 3A, the heating track 120 has a first portion 121 adjacent to the base portion 111 of the substrate 110, and a second portion 122 adjacent to the top portion 112 of the substrate 110. In other words, the heating track 120 extends to both the top and the base of the heating cavity 105, since space adjacent to the top portion 112 or base portion 111 of the substrate 110 does not need to be kept for providing the at least one electrical contact 140. This reduces the size of the substrate 110 and improves the efficiency of the heater 100. As used herein, the term “adjacent” indicates that the portion 121, 122 of the heating track 120 enters a region within 20% of the length of the substrate 110 from the top portion 112 or base portion 111, more preferably within 10%, and even more preferably within 5%.

The heating track 120 has a third portion 123 adjacent to the first side 113 of the substrate 110, and a fourth portion 124 adjacent to the second side 114 of the substrate 110. In other words, the heating track 120 extends to both sides of the heating cavity 105, since space does not need to be kept for providing the at least one electrical contact 140. This allows the size of the substrate 110 to be further reduced without decreasing the size of the heating track 120, which improves the overall efficiency of the heater 100 without affecting performance. As used herein, the term “adjacent” indicates that the portion 123, 124 of the heating track 120 enters a region within 20% of the width of the substrate 110 from the first side 113 or the second side 114, more preferably within 10%, and still more preferably within 5%.

Preferably, the heating track 120 substantially follows the perimeter of the substrate 110 at other portions in addition to the first, second, third, and fourth portions described above (i.e., the heating area 115 extends to the perimeter of the substrate 110). In other words, the portions 121, 122, 123, 124 depicted in FIG. 3A are not the only portions adjacent to the respective side of the substrate, and have been labelled by way of example only. For both rectangular and non-rectangular substrates 110, the heating area 115 preferably extends to the perimeter of the substrate 110 (i.e., where the boundary of the heating area 115 is adjacent to the perimeter of the substrate 110, with the term “adjacent” being defined as above).

As shown in FIG. 3B, at least one wire 150 extends from the at least one electrical contact 140. More specifically, a first wire 150-1 extends from the first electrical contact 140-1, a second wire 150-2 extends from the second electrical contact 140-2, a third wire 150-3 and a fourth wire 150-4 extend from the electrical contacts 140 of the temperature sensor 130. As will be described later in more detail, the wires 150 preferably extend in a direction that is perpendicular from the surface 118 of the substrate 110 and a portion of the wire 150 is bent in a direction that is parallel to the surface 118 of the substrate 110. This allows the wires 150 to connect to other components of the device 1 such as the power supply or control circuitry. In this example, all of the wires 150 are bent to extend over the base 101 of the heater 100 but it will be appreciated that the wires 150 may be bent to extend in other directions or may not be bent at all.

Advantageously, by providing the electrical contacts 140 within the heating area 115, the energy efficiency of the heater 100 is improved. The energy consumed is generally proportional to the area of the substrate 110. In the typical heater 100′ shown in FIGS. 2A and 2B the surface area is 329 mm² , which required about 3 KJ of energy per session. With the heater 100 shown in FIGS. 3A and 3B, the surface area is reduced to 263 mm² , which requires only about 2.6 KJ of energy per session. This represents approximately a 20% improvement in energy efficiency whilst still maintaining performance of the device 1.

In order to further improve the efficiency of the device 1, it is desirable to maximise the amount of heat from the heating track 120 transferred to the cavity 105, and minimise any leakage of heat elsewhere. This improves the battery life of the device 1 without affecting performance of the heater 100, and may reduce heating of the outside of the device 1 during use. In order to achieve this, the heating assembly 10 comprises an insulating layer 50 positioned over the surface 118 of the substrate 110. The insulating layer 50 may also be referred to herein as an insulating plate 50.

As shown in FIG. 4, the insulating layer 50 may be a substantially rectangular piece of material. The material may be about 3 mm thick, though as will be described later, multiple insulating layers 50 may be used in order to provide a total thickness of about 3 mm, with each layer preferably having a thickness of about 1 mm or less. The insulating layer 50 has a nanoporous structure and may comprise a material such as Superwool® or Finesulight™.

As described previously, since the wires 150 extend from the central region of the surface 118 of the substrate 110, one problem may be how to effectively insulate the heater 100 while still allowing the wires 150 to connect to other parts of the device 1. By contrast, in the arrangement shown in FIGS. 2A and 2B, an insulating layer may be easily provided over the heating area 115′ without being obstructed by the electrical contacts 140′ or the wires 150′. In order to address this problem in the present example, the insulating layer 50 is arranged to provide an opening through which the wire 150 extends. As shown in FIG. 4, the insulating layer 50 comprises at least one hole or perforation 52, and more specifically a hole 52 corresponding to each of the wires 150. In this example, a first hole 52-1 and second hole 52-2 correspond to the first wire 150-1 and second wire 150-2 that connect to the heating track 120. A third hole 52-3 and a fourth hole 52-4 correspond to the third wire 150-3 and the fourth wire 150-4 that connect to the temperature sensor 130.

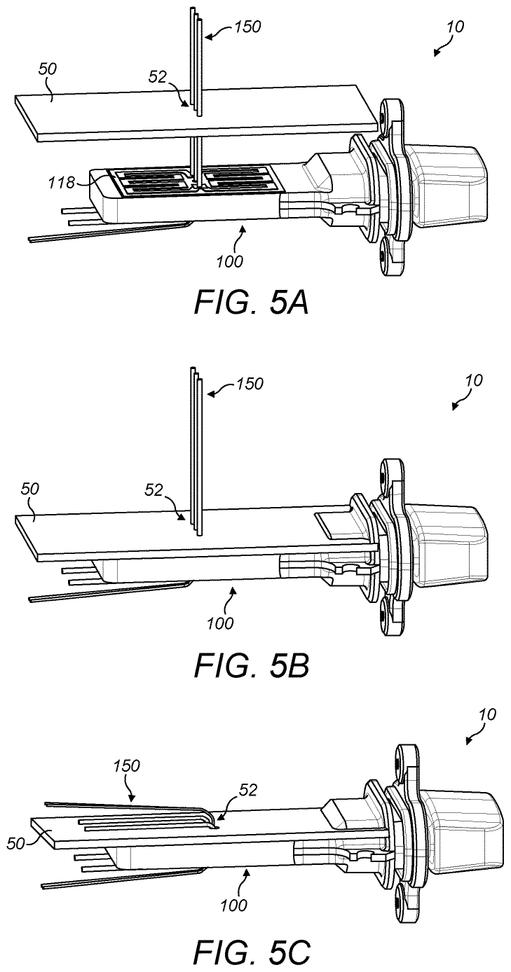

FIGS. 5A to 5C show steps during construction of the heating assembly 10. In FIG. 5A, an end of each wire 150 is passed through its corresponding hole 52. In FIG. 5B, the insulating layer 50 is positioned against the surface 118 of the substrate 110, with the wires 150 moving through the holes 52. The size of each hole 52 tightly seals around its corresponding wire 150 which means that there is no part of the surface 118 that is not covered by the insulating layer 50. Preferably, the insulating layer 50 contacts the surface 118 of the substrate 110; alternatively, an air layer may be provided therebetween, which may provide additional insulation.

As shown in FIG. 5C, a portion of each wire 150 that extends through the hole 52 is bent parallel to the insulating layer 50. This retains the insulating layer 50 against the surface 118 of the heating substrate 110. While FIGS. 5A to 5C only show a single insulating layer 50 being positioned over a first heating substrate 110a, it will be appreciated that the same process may occur for the second heating substrate 110b, so that both sides of the heater 100 are insulated. Furthermore, other heating layers may be provided to cover the base 101 and side walls 103, 104 of the heater 100. As will be described later in more detail, the insulating layer 50 may be bent (folded or wrapped) to cover the base 101 and side walls 103, 104.

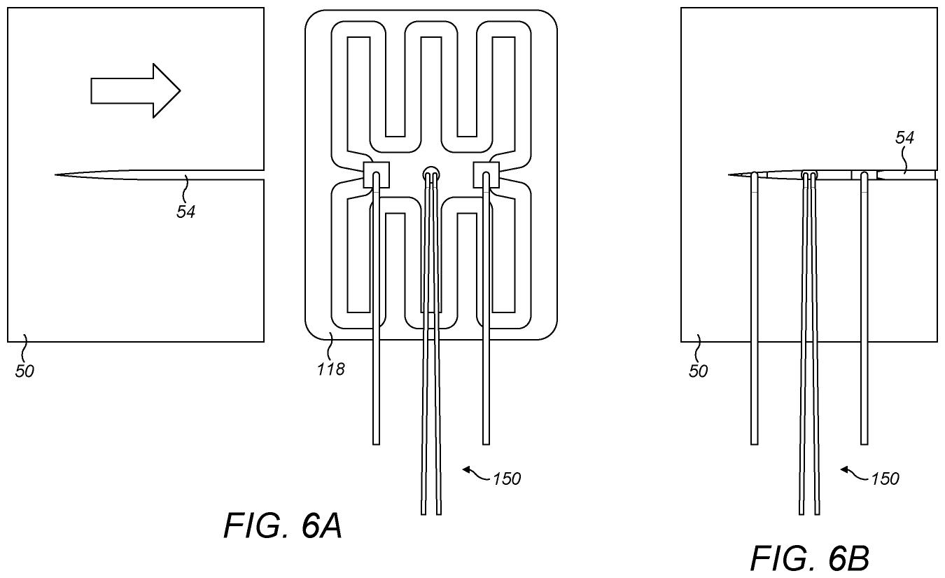

The opening may be provided in other ways. As shown in FIGS. 6A and 6B, the insulating layer 50 may comprise a slot 54 extending to an edge of the insulating layer 50. In this way, the insulating layer 50 may be positioned by translating it over the surface 118 of the substrate 110 with the wires 150 extending through the slot 54. Since the electrical contacts 140 are preferably co-linear, the slot 54 may be a straight line, thereby allowing the insulating layer 50 to be easily slid into position along a single direction (as shown with the arrow). While a straight slot 54 may be manufactured more easily, it will be appreciated that other shapes of slot 54 may be used to correspond to other (e.g., non-co-linear) arrangements of electrical contacts 140. Where a slot 54 is used, the wires 150 may also be bent parallel to the insulating layer 50 to retain the insulating layer 50 against the heating substrate 110; this may occur either before or after the insulating layer 50 is positioned over the substrate 110, but preferably after.

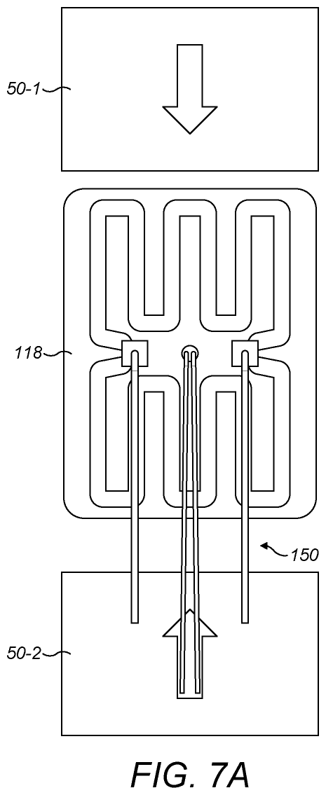

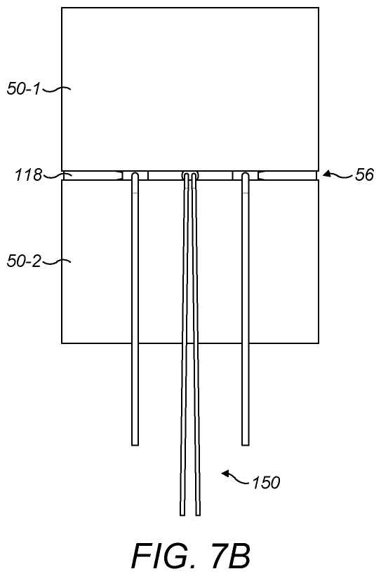

As another alternative way to provide an opening, FIGS. 7A and 7B depict an insulating layer 50 with a first portion 50-1 and a second portion 50-2 that are positioned over the substrate 110 with a gap 56 therebetween that provides the opening. As shown by the arrows in in FIG. 7A, the first portion 50-1 and the second portion 50-2 may be translated (slid) over the surface 118 of the heating substrate 110 in order to position them. In FIG. 7B the first portion 50-1 and the second portion 50-2 have been slid so that the abut the wires 150 connected to the electrical contacts 140. Since the electrical contacts 140 are preferably co-linear, the insulating layer 50 may be simply divided into the first and second portion 50-1, 50-2 along a straight line. While a straight gap 56 (boundary) may be manufactured more easily, it will be appreciated that other shapes of gap 56 may be used, such as to account for electrical contacts 140 that are not co-linear, and/or to fill the space between electrical contacts 140.

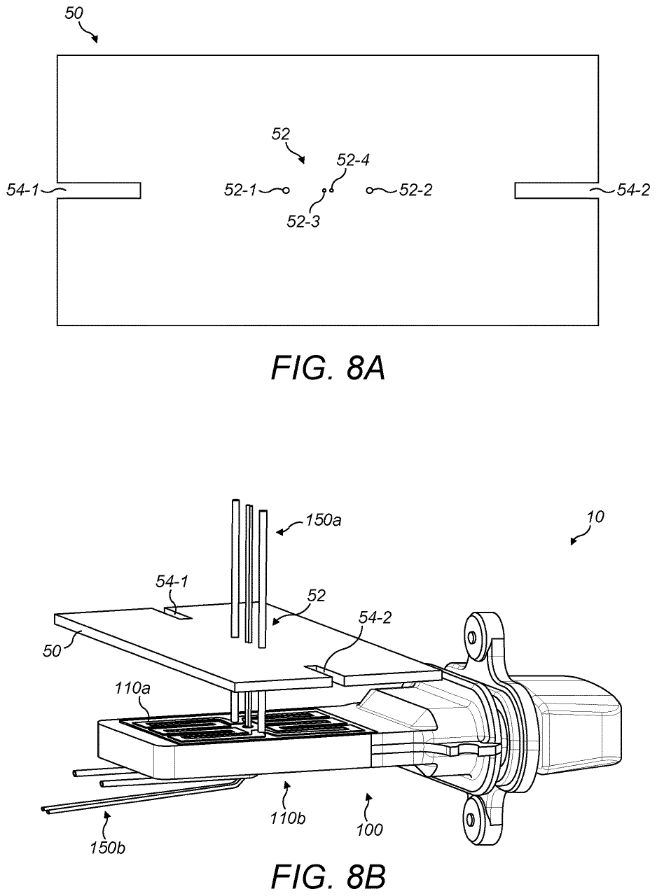

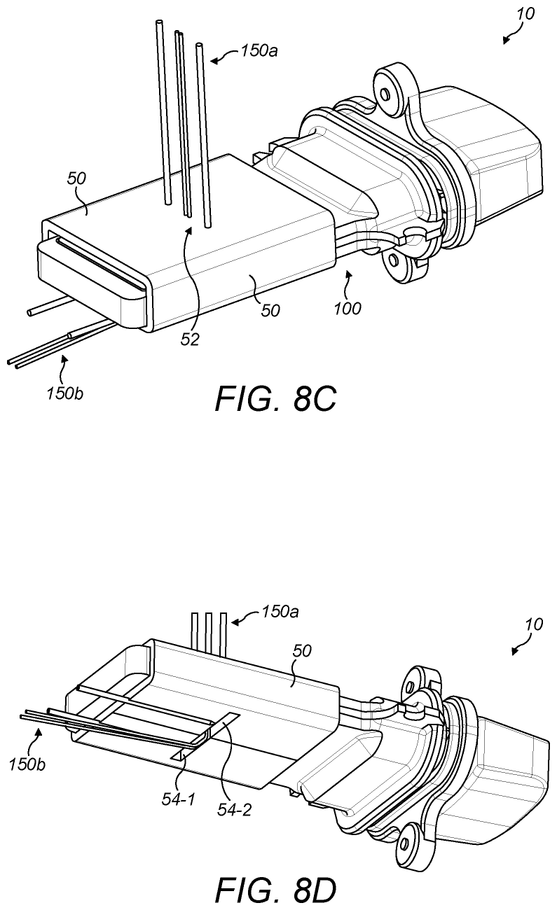

FIGS. 8A to 8D show an alternative way to provide an opening of the insulating layer 50, where the insulating layer 50 is wrapped around the heater 100. As shown in FIG. 8A, the insulating layer 50 comprises holes 52 corresponding to those described already in relation to FIG. 4. However, the insulating layer 50 is also wider and has slots 54-1 54-2 on its sides.

As shown in FIG. 8B, a first set of wires 150a extends from the first substrate 110a, and a second set of wires 150b extends from the second substrate 110b. In a similar manner to FIG. 5A, an end of each wire 150a is passed through its corresponding hole 52 in order to position the insulating layer 50 against the surface 118 of the first substrate 110a, as shown in FIG. 8B. In FIG. 8C, the insulating layer 50 is bent (i.e., wrapped and/or folded) around the side walls 103, 104 of the heater 100 in order to position the insulating layer 50 against the surface 118 of the second substrate 110b. The insulating layer 50 is bent about a longitudinal axis of the heater 100, which is an axis extending between the base 101 of the heater 100 and the mouthpiece 4. The insulating layer 50 may be sealed to itself and/or to the heater 100 in order to prevent it from subsequently becoming unwrapped. Since the heater 100 is a cuboid shape, the insulating layer 50 may be bent over the 90-degree corners of the heater 100 without the insulating layer 50 becoming substantially creased.

As shown in FIG. 8D, the slots 54-1, 54-2 allow the second set of wires 150b to extend through the insulating layer 50. While in this example, the insulating layer 50 is wrapped around the side walls 103, 104 of the heater 100, it will be appreciated that the insulating layer 50 could be wrapped under the base 101 of the heater 100, which may require a different configuration of holes 52 and slots 54, or a different shape of the insulating layer 50. It will also be appreciated the first set of wires 150a may instead pass through the slots 54 and the second set of wires 150b may instead pass through the holes 52 of the insulating layer 50. Any features of the insulating layers 50 described above may be combined in any suitable way. For example, rather than provide the slots 54 at the sides of the insulating layer 50 in FIG. 8A, the insulating layer 50 may be narrowed slightly so that the wires instead extend through a gap when the insulating layer 50 is folded around the heater 100.

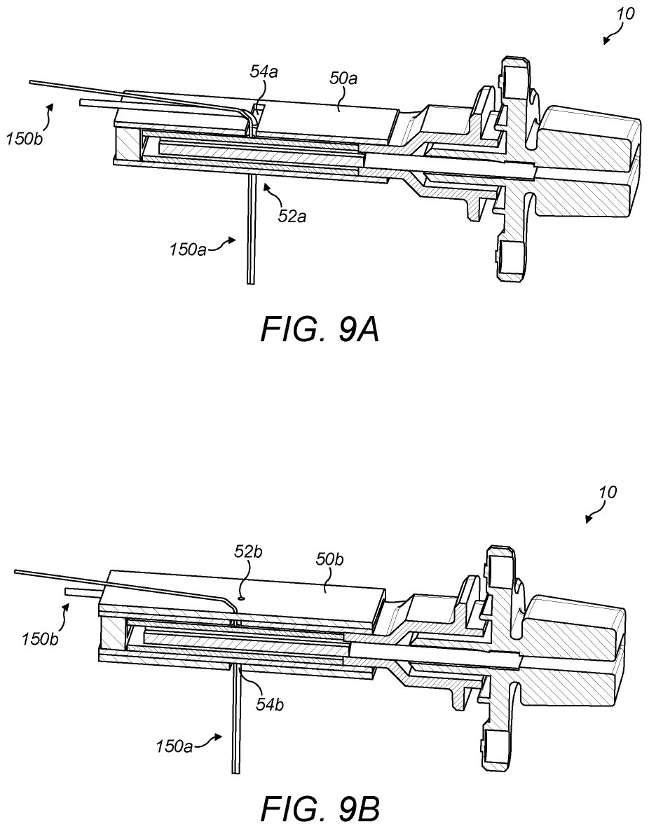

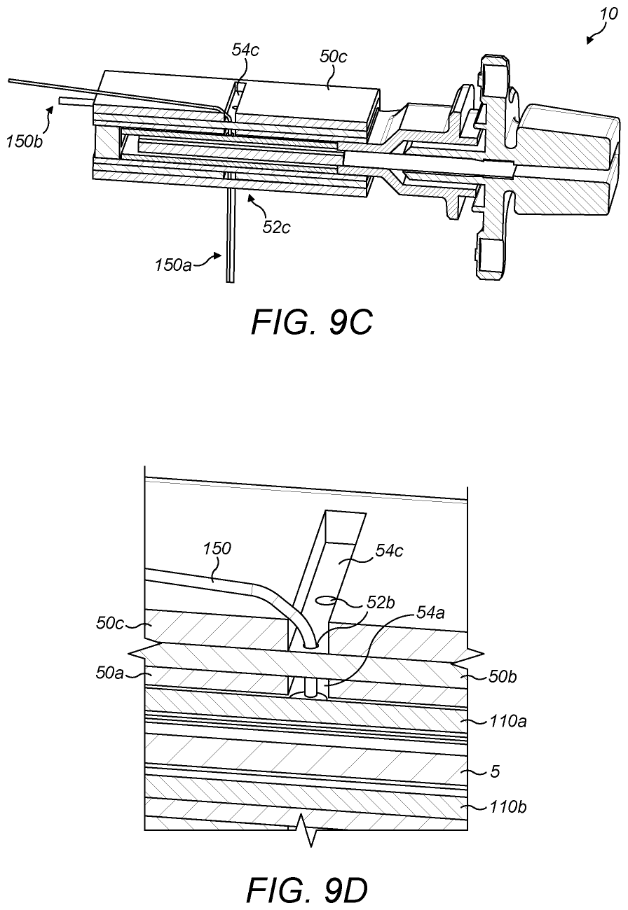

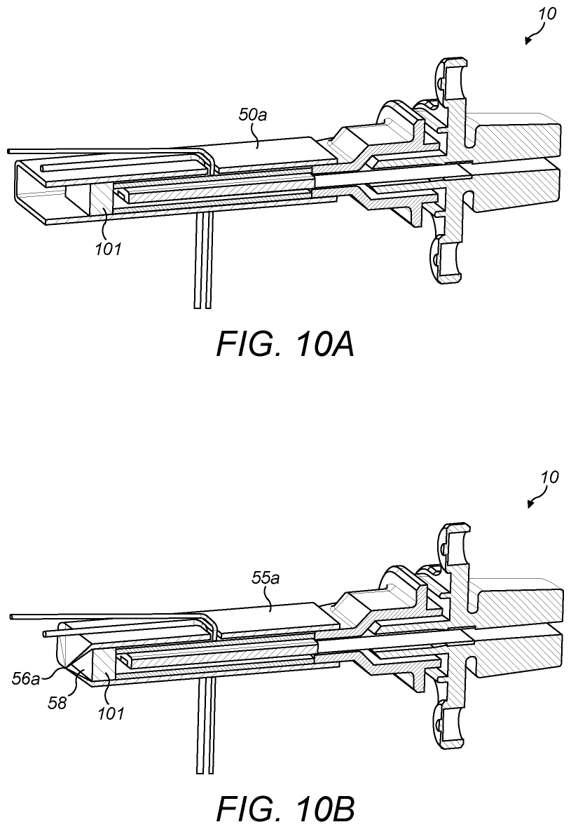

As will now be described in relation to FIGS. 9A to 9D, multiple insulating layers 50 may be wrapped on top of each other. In FIG. 9A, a first insulating layer 50a is wrapped around the heater 100, in a similar manner to as described in relation to FIGS. 8A to 8D. The first set of wires 150a extend through holes 52a in the first insulating layer 50a, and the second set of wires 150b extend through slots 54a in the first insulating layer 50a. While the first insulating layer 50a does cover most of the heater 100, the slots 54a mean that parts of the second substrate 110b near the second set of wires 150b (such as between adjacent wires 150) are not covered by the first insulating layer 50a.

In FIG. 9B, a second insulating layer 50b is wrapped around the heater 100 on top of the first insulating layer 50a, in a similar manner to as described previously. Preferably, the second insulating layer 50b is wrapped to cover an opening in the first insulating layer 50a. More specifically, the slot 54a in the first insulating layer 50a is covered by the second insulating layer 50b. This is achieved by passing the second set of wires 150b through holes 52b in the second insulating layer 50b and passing the first set of wires 150a through slots 54b in the second insulating layer 50b. In other words, where a particular wire 150 extends through a slot 54a in the first insulating layer 50a, the same wire 150 may extend through holes 52b in the second insulating layer (and vice versa). Since holes 52, (which are preferably tightly sealed around the wires 150) provide better insulation than slots 54 (which leave areas uncovered), this means that all sides of the heater 100 are covered by at least one insulating layer 50.

Preferably, as shown in FIG. 9C, a third insulating layer 50c is wrapped around the heater 100. Similarly to as described above, the third insulating layer 50c is wrapped to cover an opening in at least one of the first or second insulating layers 50a, 50b. In particular, the slot 54b in the second insulating layer 50b is covered by the third insulating layer 50c. Accordingly, the third insulating layer 50c is wrapped in a similar manner to the first insulating layer 50a, but it will be appreciated that the third insulating layer 50c may be wrapped differently to either or both of the first and second insulating layers 50a, 50b.

FIG. 9D shows a close-up of FIG. 9C. As shown, the wire 150 alternates between passing through a slot 54 and passing through a hole 52. By wrapping the heater 100 in this way, it is possible to cover substantially all of the heater 100 while still providing openings through which the wires 150 extend. A further advantage of having multiple insulating layers 50 is that each layer may be made thinner and can therefore be wrapped more tightly around the 90-degree corners of the heater 100. For example, a total thickness of about 3 mm may be required to provide sufficient insulation; by providing this thickness using three layers that are each 1 mm thick, each insulating layer 50 may be bent at a sharper angle (with a smaller bend radius) around the corners of the heater 100.

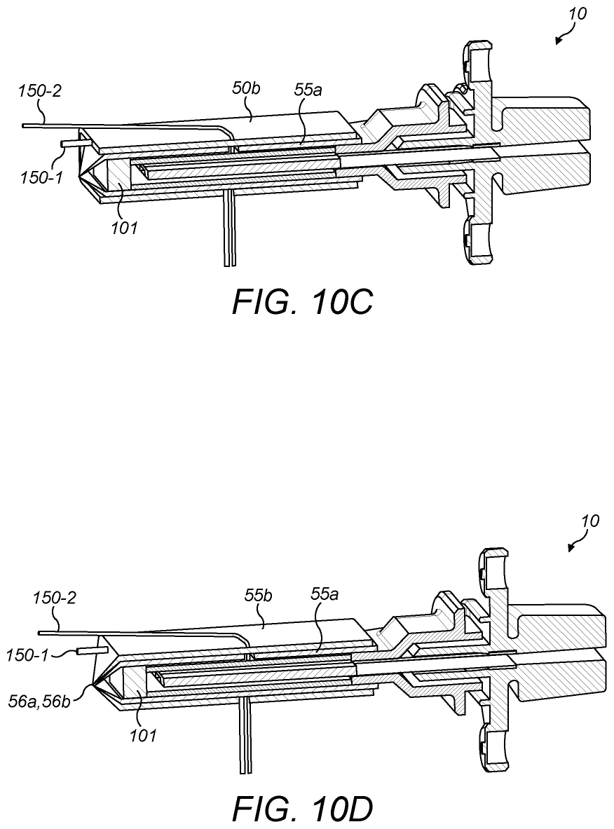

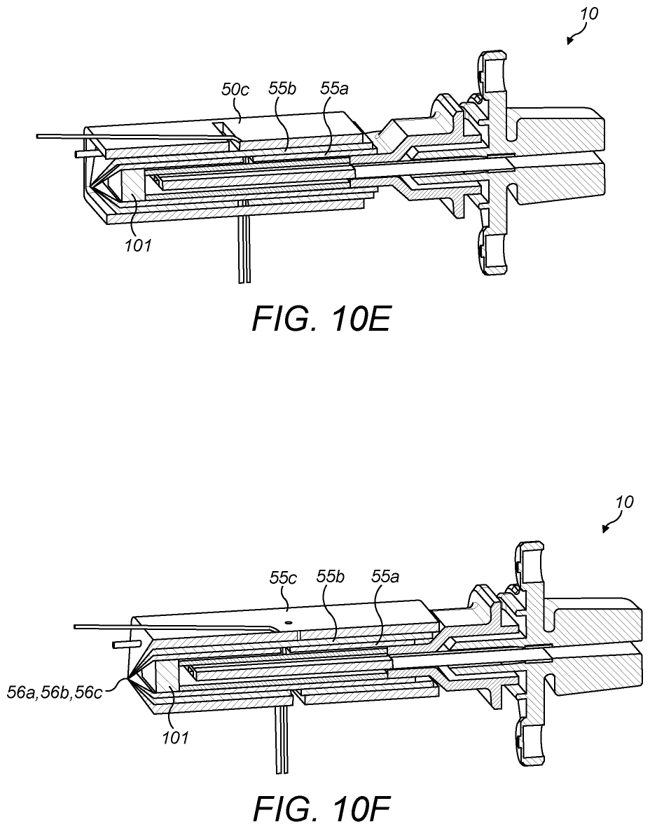

While the insulating layers 50 described above provide insulation to the substrates 110 and the side walls 103, 104 of the heater 100, the base 101 of the heater 100 remains generally uncovered. Typically, a separate piece of material may be used to insulate the base 101. However, as will now be described in relation to the cross-sectional views in FIGS. 10A to 10F, an insulating layer (referred to generally as 50) is preferably bent to form a wrapping (referred to generally as 55) that substantially surrounds the heater 100. Such a wrapping 55 may be referred to as an insulating pouch 55.

FIG. 10A shows a heating assembly 10 where an insulating layer 50a has been wrapped around the heater 100 in a similar manner to as already described. More specifically, the insulating layer 50a is bent about a first axis to cover the first substrate 110a, the opposing second substrate 110b, and the side walls 103, 104. The first axis corresponds to a longitudinal axis of the heater 100. As shown in FIG. 10A, following the bending about the first axis, the base 101 is initially uncovered or unwrapped by the insulating layer 50a. The insulating layer 50a has a height greater than the insulating layers described previously, so that a bottom edge of the insulating layer 50a extends beyond (i.e., overhangs) the base 101. Subsequently, as shown in FIG. 10B, the insulating layer 50a is bent about a second axis, perpendicular to the first axis, to cover the base 101. The second axis corresponds to an axis perpendicular to the longitudinal axis, such as an axis passing through opposing surfaces of the cavity 105. Once bent to cover the base 101, the insulating layer 50a is sealed over the base 101 to form a wrapping 55a with a seal 56a. The seal 56a is preferably a crimp seal, though other types of seal 56a may be used to connect the insulating layer 50a to itself over the base 101, such as using one or more folds in the insulating layer 50a. The wrapping 55a has a main opening that aligns with the opening of the heating cavity 105. By forming the wrapping 55a in this way, the heater 100 may be more fully insulated using a single piece of insulating material, without the need for a separate piece of material to insulate the base 101 or the side walls 103, 104. Furthermore, an air pocket 58 is formed between the base 101 and the seal 56a. Since air has a low specific heat capacity, this further reduces heat loss from the heater 100 via the base 101. Optionally, the air pocket 58 may be filled with an insulating substance.

It will be appreciated that the wrapping 55a has other openings (different to its main opening) through which the wires 150 extend, such as the holes 52 or slots 54 already described above. It will also be appreciated that the first axis and second axis may be defined using different directions.

Preferably, the wrapping 55a is a first wrapping 55a and one or more further additional insulating layers are wrapped around the heater 100. As shown in FIG. 10C, a second insulating layer 50b is bent about the first axis around the heater 100, leaving a bottom edge of the second insulating layer 50b overhanging the base 101 of the heater 100. In FIG. 10D, the second insulating layer 50b is bent about the second axis to cover the base 101, and sealed to form a second wrapping 55b with a seal 56b. This provides a pair of nested wrappings 55a, 55b, which improves insulation of the heater 100.

As shown in FIG. 10E, a third insulating layer 50c is bent about the first axis around the heater 100, leaving a bottom edge of the third insulating layer 50c overhanging the base 101 of the heater 100. In FIG. 10F, the third insulating layer 50c bent about the second axis to cover the base 101, and sealed to form a third wrapping 55c with a seal 56c. This provides a plurality of nested wrappings 55a, 55b, 55c, which further improves the insulation of the heater 100.

It will be appreciated that any number of wrappings 55 may be provided using a corresponding number of insulating layers 50, such as four or more. By using a plurality of wrappings 55, each may be formed from a thinner piece of material (e.g. about 1 mm or less), which means that each insulating layer 50 can be bent more sharply around corners of the heater 100. On the other hand, where only a single wrapping 55 is provided with a thickness of about 3 mm, the insulating layer 50 cannot be folded as sharply around the heater 100 due to the limited bend radius of the thick piece of material.

While FIG. 10F shows that all of the insulating layers 50 are sealed to form wrappings 55, it will be appreciated that not all of the insulating layers 50 are necessarily sealed. Additionally, the sealing does not necessarily need to occur before wrapping of further insulating layers 50 is completed; for example, the sealing of all three insulating layers 50 may occur simultaneously. Furthermore, the wrappings 55 may be combined with the other configurations of insulating layers 50 described previously.

Where multiple wrappings 55 are provided, the wires 150 pass through the layers in a similar way to as already described above in relation to FIGS. 9A to 9D, where the openings alternate between holes 52 and slots 54. Additionally, the wires 150 are bent parallel to the heater 100 to retain the insulating layers 50 against the substrate 110 and to connect to other components of the device 1 such as the power supply or control circuitry.

In order to further improve the insulating properties of the heater assembly 10, an air layer is provided that spaces at least one of the insulating layers 50 away from the heater 100. More specifically, adjacent pairs of insulating layers 50 are spaced apart from each other to form an air layer therebetween. Since air has a low specific heat capacity, providing air layers further improves the insulation around the heater 100. The air layer is provided in addition to the air pocket 58 described above.

As shown in FIG. 10D, the air layer is provided by spacing the first insulating layer 55a from the second insulating layer 55b using with the first wire 150-1 extending from the first substrate 110a. The first wire 150-1 is bent against the external surface of the first wrapping 55a, prior to wrapping of the second insulating layer 50b over the first insulating layer 50a. As a result, once the second insulating layer 50b is bent around the heater 100, the air layer is provided adjacent to the first wire 150-1. Since the first wire 150-1 is bent parallel to the surface 118 of the substate 110, the opening in the second insulating layer 55b through which the first wire 150-1 extends is provided towards a base of the second wrapping 55b adjacent to the seal 56b.

As shown in FIG. 10D, the second wire 150-2 is instead bent over the external surface of the second insulating layer 50b. Therefore, the second wire 150-2 extends through an opening in the second insulating layer 50b in the manner previously described in relation to FIGS. 9A to 9D. As shown in FIG. 10F, the second wire 150-2 is also bent over the external surface of the third (outermost) insulating layer 50c, and thus no air layer is provided between the second insulating layer 50b and the third insulating layer 50c. Alternatively, the second wire 150-2 may space the second insulating layer 50b from the third insulating layer 50c in order to provide an air layer.

While the air layers are described above in relation to the first wire 150-1 and second wire 150-2 extending from the first substrate 110a of the heater 100, it will be appreciated that any of the other wires 150 extending from either of the substrates 110a, 110b may be used for this purpose. In other words, any adjacent pair of insulating layers 50 may be spaced apart using any of the wires 150. Since multiple wires 150 are present in the heating assembly 10, several air layers may be formed using different wires 150. Additionally, while not described above, a wire 150 may be bent directly between the heater 100 and the first insulating layer 50a.

While the foregoing is directed to exemplary embodiments of the present invention, it will be understood that the present invention is described herein purely by way of example, and modifications of detail can be made within the scope of the invention. Furthermore, one skilled in the art will understand that the present invention may not be limited by the embodiments disclosed herein, or to any details shown in the accompanying figures that are not described in detail herein or defined in the claims. Indeed, such superfluous features may be removed from the figures without prejudice to the present invention.

Moreover, other and further embodiments of the invention will be apparent to those skilled in the art from consideration of the specification, and may be devised without departing from the basic scope thereof, which is determined by the claims that follow.

1. A heating assembly for a heat-not-burn device, comprising:
a heater arranged around an internal heating cavity with an opening arranged to receive a consumable article; and
an insulating layer bent about a first axis around the heater to cover at least a first outer surface of the heater and a second outer surface of the heater, wherein the second surface opposes the first surface, and wherein the insulating layer is bent about a second axis that is perpendicular to the first axis, to cover a third outer surface of the heater that connects the first surface to the second surface,
wherein the insulating layer is sealed to form a wrapping around the heater.

2. The heating assembly of claim 1, wherein the third surface of the heater is at a base of the heater opposite to the opening of the heating cavity.

3. The heating assembly of claim further comprising one or more additional insulating layers, each bent to cover at least the first surface and the second surface of the heater, wherein at least one of the one or more additional insulating layers is bent about the second axis to cover the third surface of the heater and sealed.

4. The heating assembly of claim 1, wherein the insulating layer is less than 1 mm thick.

5. The heating assembly of claim 1, further comprising a wire extending from an external surface of the heater, and wherein the insulating layer comprises an opening through which the wire extends.

6. The heating assembly of claim 5, wherein a portion of the wire that extends through the opening is bent against an external surface of the insulating layer.

7. The heating assembly of claim 1, wherein an air layer is provided between the insulating layer and the heater.

8. The heating assembly of claim 7, wherein the air layer is provided between the insulating layer and the third surface of the heater.

9. The heating assembly of claim 6, wherein an air layer is provided between the insulating layer and the heater, and the air layer is provided by spacing the insulating layer away from the heater by the wire.

10. The heating assembly of claim 9, further comprising one or more additional insulating layers, each bent to cover at least the first surface and the second surface of the heater, wherein at least one of the one or more additional insulating layers is bent about the second axis to cover the third surface of the heater and sealed, wherein the wire is bent between a first of the insulating layers and a second of the insulating layers, thereby providing the air layer therebetween.

11. The heating assembly of claim 5, further comprising one or more additional insulating layers, each bent to cover at least the first surface and the second surface of the heater, wherein at least one of the one or more additional insulating layers is bent about the second axis to cover the third surface of the heater and sealed, wherein the opening of a first of the insulating layers is covered by a second of the insulating layers.

12. The heating assembly of claim 1, wherein the heater comprises:
a first heating substrate providing the first outer surface of the heater, and a second heating substrate arranged parallel to the first heating substrate, the second heating substrate providing the second outer surface of the heater and a substantially planar heating cavity between the first heating substrate and the second heating substrate.

13. A heat-not-burn device comprising the heating assembly of any claim 1.

14. A method of manufacturing a heating assembly for a heat-not-burn device, comprising:
providing a heater arranged around an internal heating cavity with an opening arranged to receive a consumable article;
bending an insulating layer about a first axis around the heater to cover at least a first outer surface of the heater and a second outer surface of the heater, wherein the second surface of the heater opposes the first surface;
bending the insulating layer about a second axis, perpendicular to the first axis, to cover a third outer surface of the heater that connects the first surface to the second surface; and
sealing the insulating layer of the heater to form a wrapping around the heater.

15. The method of claim 14, further comprising bending one or more additional insulating layers around the heater to cover at least the first surface and second surface thereof, with at least one of the one or more additional insulating layers being bent about the second axis to cover the third surface of the heater and sealed.
